(19) United States
(12) Patent Application Publication
(10) Pub. No.: US 2019/0094572 A1
(43) Pub. Date: Mar. 28, 2019

(54) HEAT DISSIPATION STRUCTURE OF A PAIR OF GLASSES

(71) Applicant: Lin Yun CHEN, Tainan City (TW)

(72) Inventor: Lin Yun CHEN, Tainan City (TW)

(21) Appl. No.: 15/719,507

(22) Filed: Sep. 28, 2017

(51) Int. Cl. G02C 11/08

(52) U.S. Cl. CPC G02C 11/08

(57) ABSTRACT

Provided is a heat dissipation structure of a pair of glasses, including a spectacle frame and at least one heat dissipation device. The spectacle frame includes a lens slot. The at least one heat dissipation device includes a plate body and a frame body. The plate body is provided with an upper pivot and a lower pivot. The frame body is provided with an upper pivot hole and a lower pivot hole, an upper convex portion and a lower convex portion. The upper pivot and the lower pivot of the plate body respectively corresponds to the upper pivot hole and the lower pivot hole, such that the plate body is pivoted relative to the frame body. The upper convex portion and the lower convex portion of the frame body are accommodated in the lens slot so as to fix the frame body on the spectacle frame.

### BACKGROUND OF THE INVENTION

### 1. Field of the Invention

The present disclosure relates to a pair of glasses, and particularly relates to a heat dissipation structure of a pair of glasses.

### 2. The Prior Arts

With the continuous progress of science and technology, glasses in technology and application materials have been a lot of breakthroughs, in recent years, more and more people wear glasses in sports or at work. However, the main purpose of wearing glasses is to protect the eyes.

Moreover, since there may be a strong impact or collision in the movement, the glasses that can completely protect the eyes are developed, that is, sports windproof glasses, also known as sports glasses.

However, due to the glasses that can completely cover the wearer's eyes during exercise or at work, it will cause the eyes not to be properly ventilated or cause hot air around the eyes not to be effectively dissipated. Unless the wearer removes the glasses, otherwise the wearer's eyes will remain in a state of airtight for a long time.

Therefore, in addition to the glasses applicable to a variety of different sports and working environments, the glasses allows the wearer's eyes to be properly ventilated and allows hot air around the eyes to be properly dissipated. The glasses can also effectively protect the eyes. Accordingly, how to provide a better glasses cooling structure is indeed one of the important issues.

### SUMMARY OF THE INVENTION

In order to achieve the above objective, according to one preferred embodiment, the present disclosure provides a heat dissipation structure of a pair of glasses, including a spectacle frame, having a lens slot; and at least one heat dissipation device, having a plate body and a frame body, wherein the plate body is provided with an upper pivot and a lower pivot, the frame body is provided with an upper pivot hole, a lower pivot hole, an upper convex portion and a lower convex portion, the upper pivot and the lower pivot respectively corresponds to the upper pivot hole and the lower pivot hole, such that the plat body is pivoted relative to the frame body, and the upper convex portion and the lower convex portion of the frame body are accommodated in the lens slot so as to fix the fame body on the spectacle frame.

Preferably, the present disclosure further includes a frame pad, having at least one hook, wherein the at least one hook is provided on both sides of the frame pad so as to enable the at least one hook of the frame pad to hook at least one hook hole of the spectacle frame.

Preferably, the frame pad further includes a plurality of ventilation holes.

Preferably, the frame pad further includes foam, and the foam is provided on the inside of the frame pad.

Preferably, the frame pad may also be high density foam.

Preferably, the side of the frame body further includes a side convex portion, the spectacle frame further includes a recess, and the side convex portion of the side of the frame body is received in the recess of the spectacle frame to fix the frame body on the spectacle frame.

Preferably, one-piece lens or two lenses are embedded in the lens slot of the spectacle frame.

Moreover, according to another preferred embodiment, the present disclosure also provides a heat dissipation structure of a pair of glasses, including a spectacle frame, having a lens slot; and at least one heat dissipation device, having a plate body and a frame body, wherein the frame body is integrally formed on the spectacle frame, the plate body is provided with a first upper pivot hole and a first lower pivot hole, the frame body is provided with a second upper pivot hole and a second lower pivot hole, the first upper pivot hole and the first lower pivot hole respectively corresponds to the second upper pivot hole and the second lower pivot hole, and the plate body being axially assembled within the frame body by sequentially passing through the second upper pivot hole, the first upper pivot hole, the first lower pivot hole and the second lower pivot hole is pivoted, relative to the frame body.

### BRIEF DESCRIPTION OF THE DRAWINGS

FIG. 1 shows a three-dimensional decomposition diagram of two lenses and a heat dissipation structure in accordance with a first preferred embodiment of the present disclosure.

FIG. 2 shows a three-dimensional diagram of the heat dissipation structure in accordance with the first preferred embodiment of the present disclosure.

FIG. 3 shows a three-dimensional diagram of the pair of glasses having a heat dissipation structure in accordance with the first preferred embodiment of the present disclosure.

FIG. 4 shows a cross-sectional view taken along lines A-A of FIG. 3 in accordance with the first preferred embodiment of the present disclosure.

FIG. 5 shows a top view of the heat dissipation structure in accordance with the first preferred embodiment of the present disclosure.

FIG. 6 shows a top view of an opened plate body of the heat dissipation structure being opened in accordance with the first preferred embodiment of the present disclosure.

FIG. 7 shows a three-dimensional decomposition diagram of one-piece lens and a heat dissipation structure in accordance with a second preferred embodiment of the present disclosure.

FIG. 8 shows a three-dimensional diagram of the pair of glasses having one-piece lens and the heat dissipation structure in accordance with the second preferred embodiment of the present disclosure.

FIG. 9 shows a three-dimensional decomposition diagram of a spectacle frame, a frame pad and a heat dissipation structure in accordance with a third preferred embodiment of the present disclosure.

FIG. 10 shows a three-dimensional diagram of the spectacle frame, the frame pad and the heat dissipation structure in accordance with the third preferred embodiment of the present disclosure.

FIG. 11 shows a top view of the heat dissipation structure in accordance with the third preferred embodiment of the present disclosure.

FIG. 12 shows a top view of a plate body of the heat dissipation structure being opened in accordance with the third preferred embodiment of the present disclosure.

FIG. 13 shows a top view of a side convex portion on the side of the frame body of the heat dissipation structure that is accommodated in a groove of a spectacle frame in accordance with a fourth embodiment of the present disclosure.

FIG. 14 shows a three-dimensional decomposition diagram of a frame body of the heat dissipation structure integrally formed on a spectacle frame and a plate body axially assembled within the frame body by a pivot in accordance with a fifth preferred embodiment of the present disclosure.

FIG. 15 shows a three-dimensional diagram of the frame body of the heat dissipation structure integrally formed on the spectacle frame in accordance with the fifth preferred embodiment of the present disclosure.

### DETAILED DESCRIPTION OF THE PREFERRED EMBODIMENT

The detailed description of the present disclosure is provided in combination with the accompanying drawings.

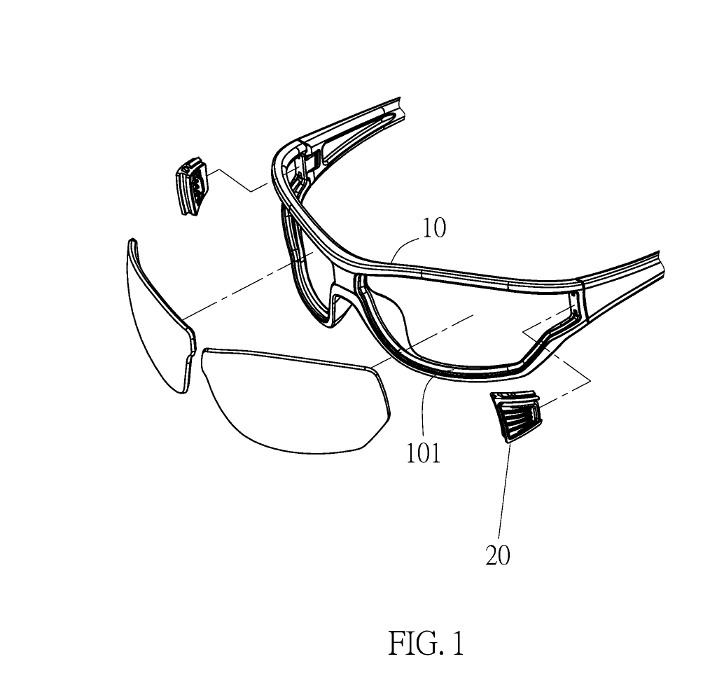

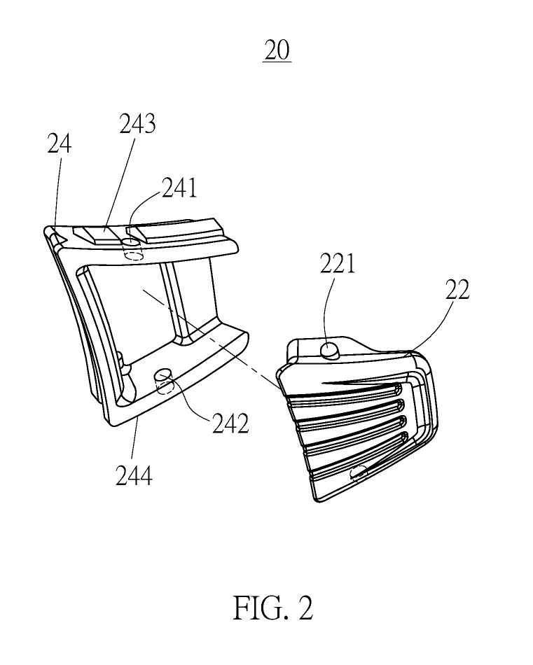

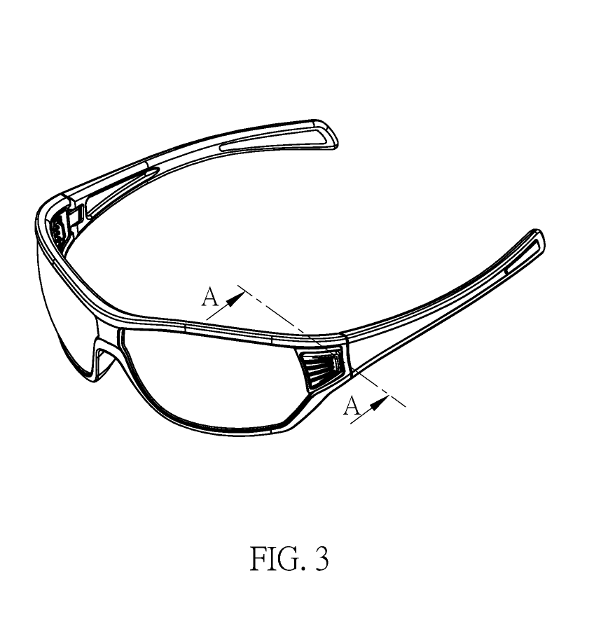

According to a first preferred embodiment of the present disclosure, FIG. 1 shows a three-dimensional decomposition diagram of two lenses and a heat dissipation structure; FIG. 2 shows a three-dimensional diagram of the heat dissipation structure; and FIG. 3 shows a three-dimensional diagram of the pair of glasses having a heat dissipation structure according to the first preferred embodiment of the present disclosure. As shown in FIG. 2, the heat dissipation structure of the present disclosure includes a spectacle frame 10 and at least one heat dissipation device 20.

As shown in FIG. 1 and FIG. 2, the spectacle frame 10 of the present disclosure includes a lens slot 101; and the at least one heat dissipation device 20 of the present disclosure includes a plate body 22 and a frame body 24, wherein the plate body 22 is provided with an upper pivot 221 and a lower pivot 222, the frame body 23 is provided with an upper pivot hole 241, a lower pivot hole 242, an upper convex portion 243 and a lower convex portion 244, the upper pivot 221 and the lower pivot 222 respectively corresponds to the upper pivot hole 241 and the lower pivot hole 242, such that the plat body 22 is pivoted relative to the frame body 24, and the upper convex portion 243 and the lower convex portion 244 of the frame body 24 are accommodated in the lens slot 101 so as to fix the fame body 24 on the spectacle frame 10.

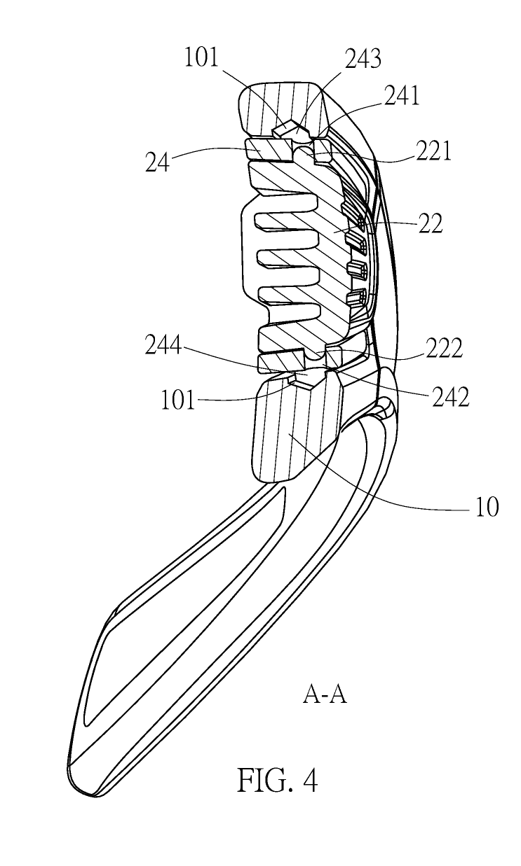

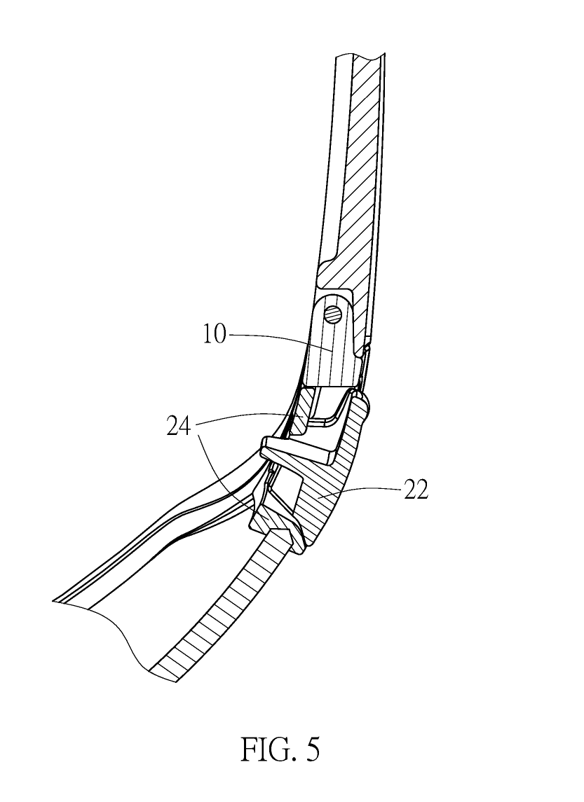

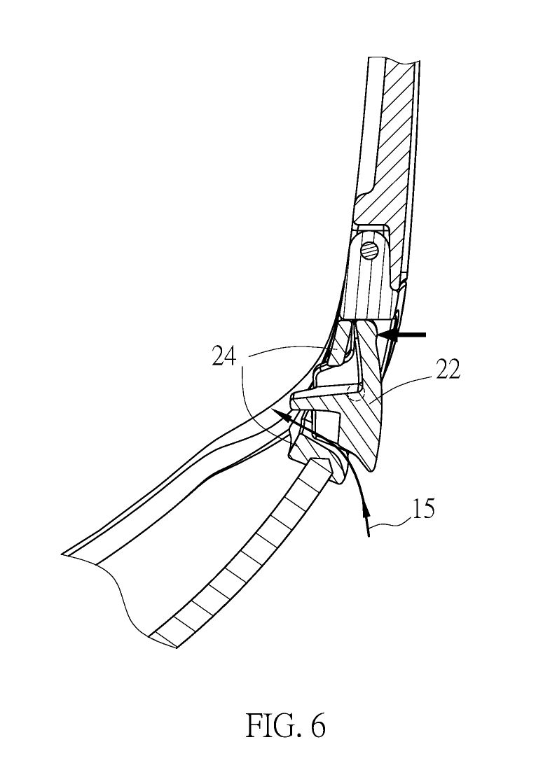

According to the first preferred embodiment of the present disclosure, FIG. 4 shows a cross-sectional view taken along lines A-A of FIG. 3; FIG. 5 shows a top view of the heat dissipation structure; and FIG. 6 shows a top view of an opened plate body of the heat dissipation structure being opened. Specifically, as shown in FIG. 6, when the rear end of the plate body 22 is pressed, the front end of the plate body 22 will be opened. The outside air can enter from the front end of the plate body 22 to effectively allow the eyes to be properly ventilated or to allow hot air around the eyes to be properly dissipated, and the eye view can be made clear. Therefore, the heat dissipation structure of the present disclosure can effectively achieve the heat dissipation effect.

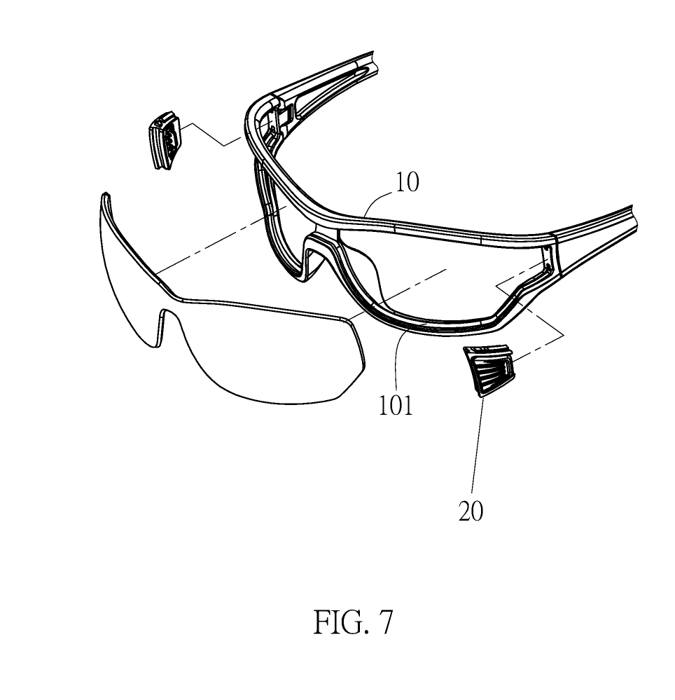

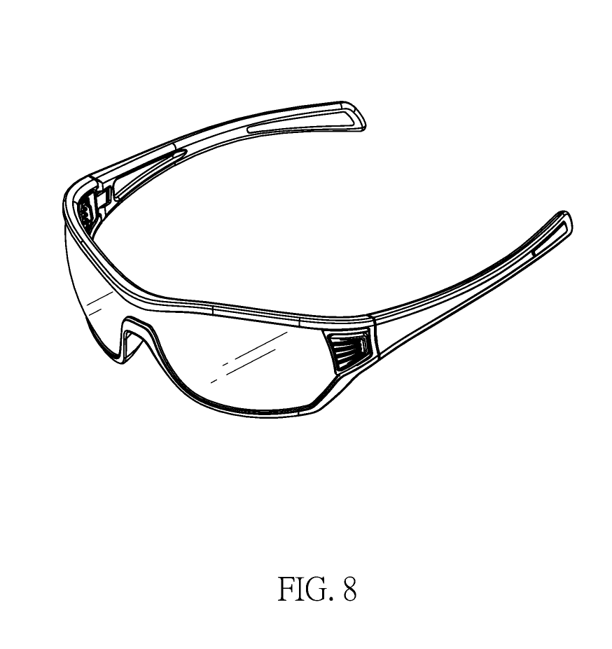

According to a second preferred embodiment of the present disclosure, FIG. 7 shows a three-dimensional decomposition diagram of one-piece lens and a heat dissipation structure; and FIG. 8 shows a three-dimensional diagram of the pair of glasses having one-piece lens and the heat dissipation structure. In other words, the heat dissipation device 20 of the present disclosure may also be assembled on a spectacle frame having one-piece lens.

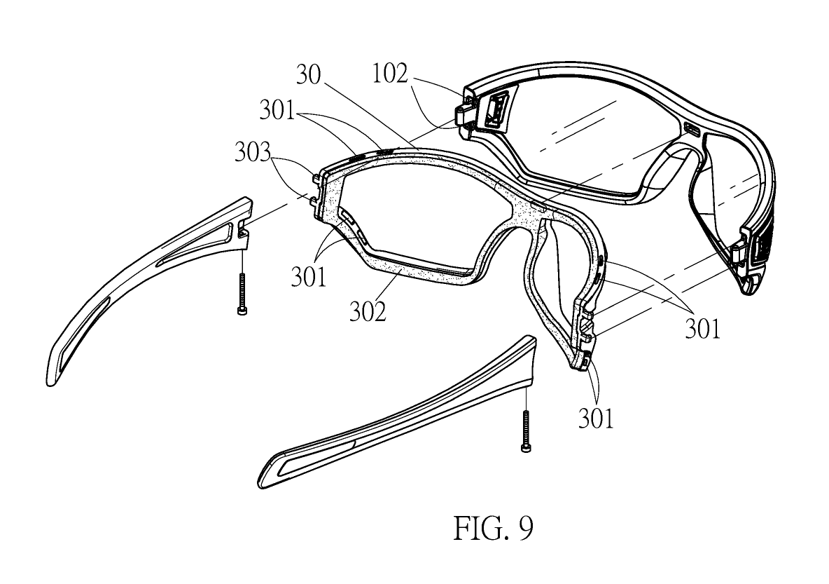

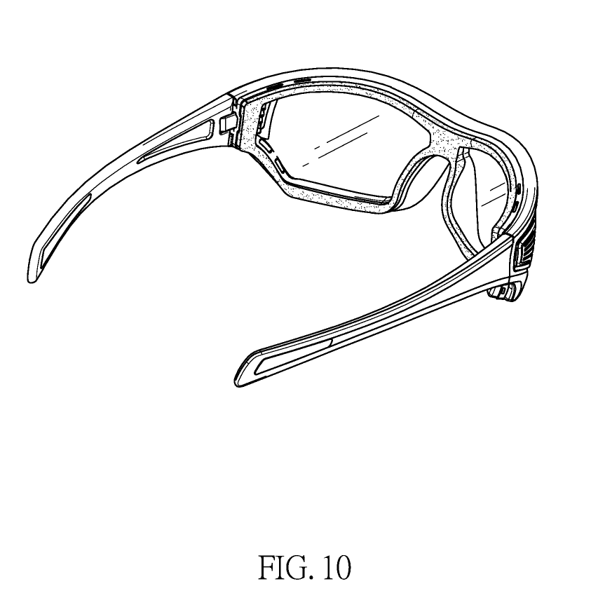

According to a third preferred embodiment of the present disclosure, FIG. 9 shows a three-dimensional decomposition diagram of a spectacle frame, a frame pad and a heat dissipation structure; and FIG. 10 shows a three-dimensional diagram of the spectacle frame, the frame pad and the heat dissipation structure. As shown in FIG. 9, the heat dissipation structure of the present disclosure may include a frame pad 30. The frame pad 30 includes a plurality of ventilation holes 301, foam 302 and at least one hook 303. The foam 302 is provided on the inside of the frame pad 30. The at least one hook 303 is provided on both sides of the frame pad 30 so as to enable the at least one hook 303 of the frame pad 30 to hook the at least one hook hole 102 of the spectacle frame 10. It is to be noted that the frame pad 30 may also be high density foam, and the material of the frame pad 30 may be made of plastic, rubber or a combination thereof.

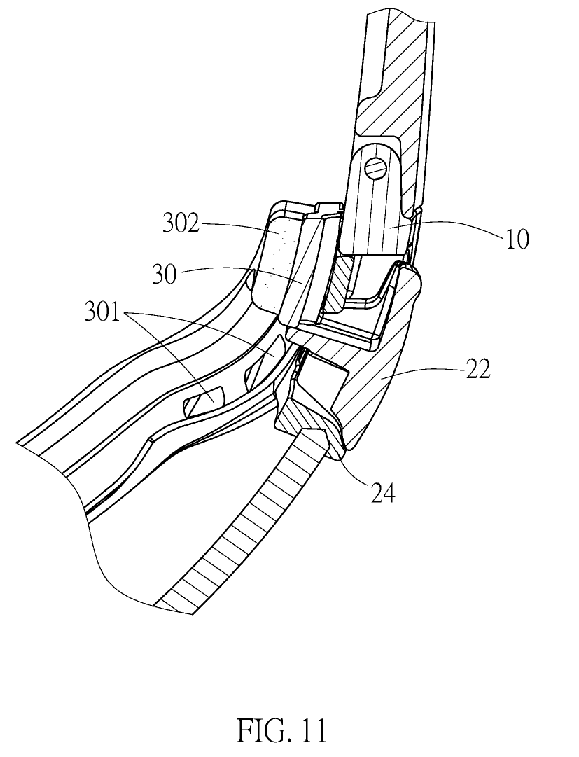

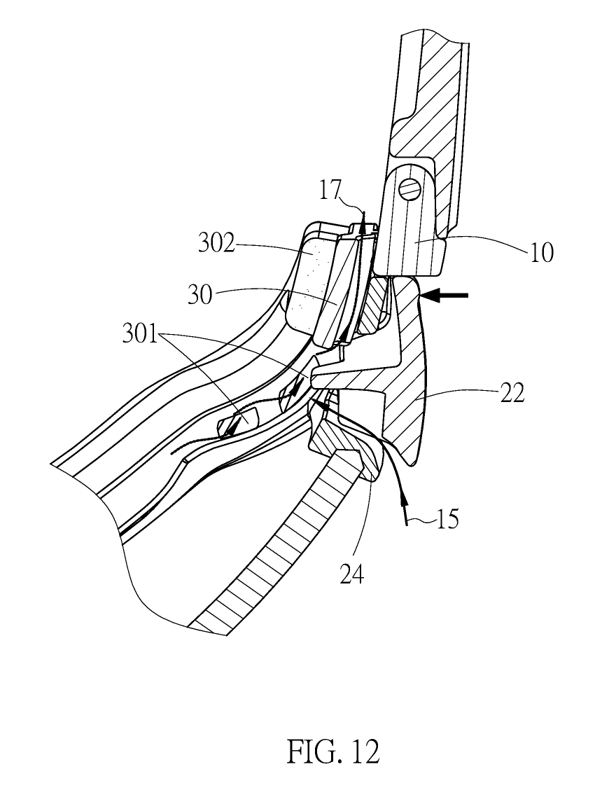

According to the third preferred embodiment of the present disclosure, FIG. 11 shows a top view of the heat dissipation structure; and FIG. 12 shows a top view of a plate body of the heat dissipation structure being opened. As shown in FIG. 12, when the rear end of the plate body 22 is pressed, the front end of the plate body 22 will be opened. The outside air can enter from the front end of the plate body 22, and the hot air in the spectacle frame is discharged by the plurality of ventilation hole 301 of the frame pad 30 so that the eyes can be effectively ventilated or hot air around the eyes can be properly dissipated. The eye view can be made clear. Therefore, the heat dissipation structure of the present disclosure can effectively achieve the heat dissipation effect.

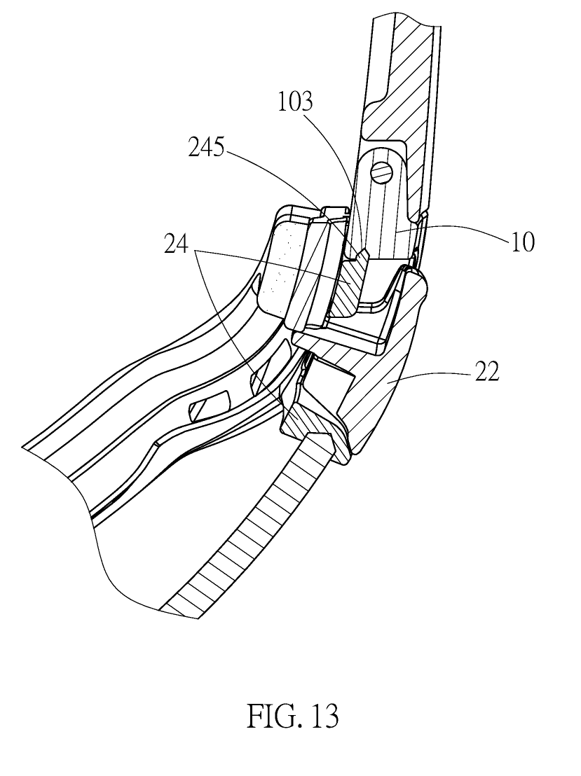

According to a fourth preferred embodiment of the present disclosure, FIG. 13 shows a top view of a side convex portion 245 on the side of the frame body 24 of the heat dissipation structure that is accommodated in a groove 103 of a spectacle frame 10. Specifically, as shown in FIG. 13, the side edge of the frame body 24 may include a side convex portion 245. Moreover, the spectacle frame 10 may include a groove 103. The side convex portion 245 of the frame body 24 may be accommodated in the groove 103 of the spectacle frame 10 so as to fix the frame body 24 to the spectacle frame 24.

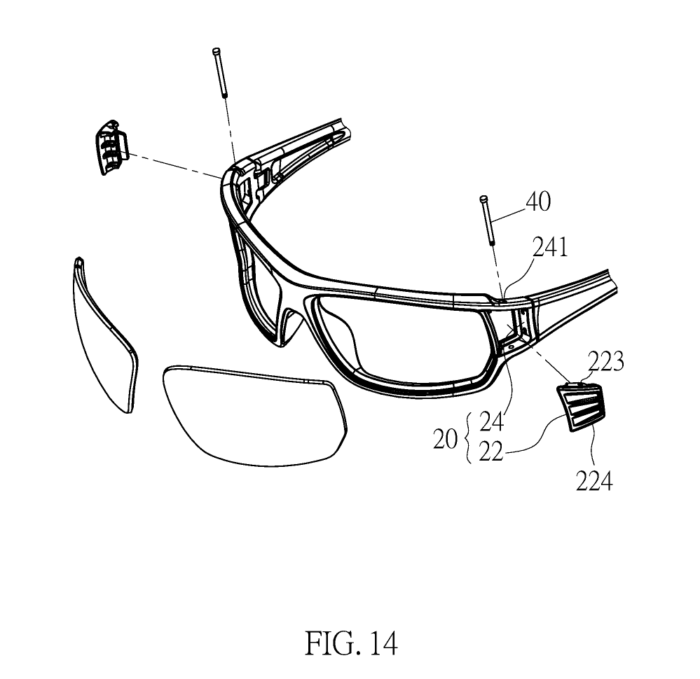

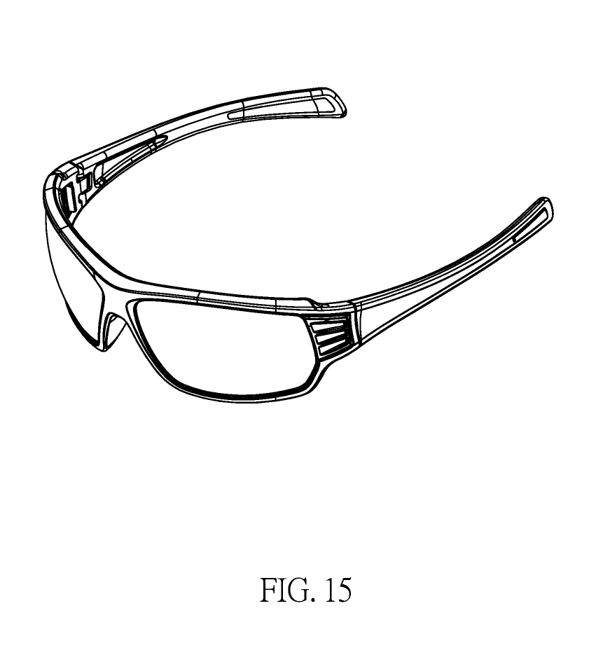

According to a fifth preferred embodiment of the present disclosure, FIG. 14 shows a three-dimensional decomposition diagram of a frame body 24 of the heat dissipation structure integrally formed on a spectacle frame 10 and a plate body 22 axially assembled within the frame body 24 by a pivot 40; and FIG. 15 shows a three-dimensional diagram of the frame body 24 of the heat dissipation structure integrally formed on the spectacle frame 10. As shown in FIG. 14, the frame body 24 of the at least one heat dissipation device 20 may be integrally formed on the spectacle frame 10. The plate body 22 is provided with a first upper pivot hole 223 and a first lower pivot hole 224. The frame body 24 is provided with a second upper pivot hole 241 and a second lower pivot hole 242. The first upper pivot hole 223 and the first lower pivot hole 224 respectively corresponds to the second upper pivot hole 241 and the second lower pivot hole 242. The plate body 22 being axially assembled within the frame body 24 by sequentially passing through the second upper pivot hole 241, the first upper pivot hole 223, the first lower pivot hole 224 and the second lower pivot hole 242 is pivoted, relative to the frame body 24.

To sum up, according to the heat dissipation structure of a pair of glasses of the present disclosure, the present disclosure has the following advantages. The heat dissipation structure of the present disclosure does not produce uncomfortable feeling at the time of wearing, is easy to assemble and is less likely to cause damage. Moreover, the heat dissipation device is less likely to come off from the spectacle frame. Accordingly, the heat dissipation structure of the present disclosure can enable the eyes to be effectively ventilated or enable hot air around the eyes to be properly dissipated and has the effect of protecting the eyes.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

1. A heat dissipation structure of a pair of glasses, comprising:
a spectacle frame, having a lens slot; and
at least one heat dissipation device, having a plate body and a frame body, wherein the plate body is provided with an upper pivot and a lower pivot, the frame body is provided with an upper pivot hole, a lower pivot hole, an upper convex portion and a lower convex portion, the upper pivot and the lower pivot respectively corresponds to the upper pivot hole and the lower pivot hole, and the plate body is assembled with the frame body, such that the plate body is pivoted relative to the frame body, and the upper convex portion and the lower convex portion of the frame body are accommodated in the lens slot so as to fix the frame body on the spectacle frame.

2. The heat dissipation structure of a pair of glasses of claim 1, further comprising: a frame pad, having at least one hook, wherein the at least one hook is provided on both sides of the frame pad so as to enable the at least one hook of the frame pad to hook at least one hook hole of the spectacle frame.

3. The heat dissipation structure of a pair of glasses of claim 2, wherein the frame pad further comprises a plurality of ventilation holes.

4. The heat dissipation structure of a pair of glasses of claim 2, wherein the frame pad further comprises foam, and the foam is provided on the inside of the frame pad.

5. The heat dissipation structure of a pair of glasses of claim 1, wherein side of the frame body further comprises a side convex portion, the spectacle frame further comprises a recess, and the side convex portion of the side of the frame body is received in the recess of the spectacle frame to fix the frame body on the spectacle frame.

6. The heat dissipation structure of a pair of glasses of claim 1, wherein one-piece lens or two lenses are embedded in the lens slot of the spectacle frame.

7. A heat dissipation structure of a pair of glasses, comprising:
a spectacle frame, having a lens slot; and
at least one heat dissipation device, having a plate body and a frame body, wherein the frame body of the at least one heat dissipation device is integrally formed on the spectacle frame, the plate body is provided with a first upper pivot hole and a first lower pivot hole, the frame body is provided with a second upper pivot hole and a second lower pivot hole, the first upper pivot hole and the first lower pivot hole respectively corresponds to the second upper pivot hole and the second lower pivot hole, and the plate body being axially assembled with the frame body by sequentially passing through the second upper pivot hole, the first upper pivot hole, the first lower pivot hole and the second lower pivot hole is pivoted, relative to the frame body.

8. The heat dissipation structure of a pair of glasses of claim 7, further comprising: a frame pad, having at least one hook, wherein the at least one hook is provided on both sides of the frame pad so as to enable the at least one hook of the frame pad to hook at least one hook hole of the spectacle frame.

9. The heat dissipation structure of a pair of glasses of claim 8, wherein the frame pad further comprises a plurality of ventilation holes.

10. The heat dissipation structure of a pair of glasses of claim 8, wherein the frame pad further comprises foam, and the foam is provided on the inside of the frame pad.

11. The heat dissipation structure of a pair of glasses of claim 7, wherein one-piece lens or two lenses are embedded in the lens slot of the spectacle frame.
